(19) United States
(12) Patent Application Publication
(10) Pub. No.: US 2024/0149695 A1
(43) Pub. Date: May 9, 2024

(54) VEHICLE AND METHOD OF CONTROLLING THE SAME

(71) Applicants: Hyundai Motor Company, Seoul (KR); Kia Corporation, Seoul (KR)

(72) Inventor: Un CHON, Seongnam-Si (KR)

(73) Assignees: Hyundai Motor Company, Seoul (KR); Kia Corporation, Seoul (KR)

(21) Appl. No.: 18/211,068

(22) Filed: Jun. 16, 2023

(30) Foreign Application Priority Data
Nov. 4, 2022 (KR) 10-2022-0146313

(51) Int. Cl. B60L 3/04; B60L 15/20; B60R 16/033; G07C 5/08

(52) U.S. Cl. CPC B60L 3/04; B60L 15/2009; B60R 16/033; G07C 5/0825; B60L 2240/12; B60L 2240/16

(57) ABSTRACT

A method of controlling a vehicle includes inputting, in response to an error occurring in a main controller configured for controlling a motor driving the vehicle, a brake signal of the vehicle to an electronic controller; confirming, in response to the brake signal being input, whether the vehicle decelerates in a drive controller; outputting, upon confirming that the vehicle does not decelerate, by the drive controller, a signal for generating a notification for inducing an emergency button mechanically or electrically connected to the main controller to operate; and cutting off power supplied to the main controller in response to the operation of the emergency button.

### CROSS-REFERENCE TO RELATED APPLICATION(S)

The present application claims priority to Korean Patent Application No. 10-2022-0146313, filed on Nov. 4, 2022, the entire contents of which is incorporated herein for all purposes by this reference.

### BACKGROUND OF THE PRESENT DISCLOSURE

### Field of the Present Disclosure

The present disclosure relates to a vehicle and a method of controlling the same, and more particularly, to a vehicle capable of urgently stopping an electric vehicle when an emergency occurs while driving the electric vehicle, and a method of controlling the same.

### Description of Related Art

Generally, eco-friendly vehicles are classified into electric vehicles, hybrid vehicles, plug-in hybrid vehicles, and fuel cell vehicles. Such an eco-friendly vehicle is driven by use of an electric motor, and includes a main battery for supplying power to the electric motor.

Furthermore, an eco-friendly vehicle, like an internal combustion engine vehicles, is provided with a software for controlling the vehicle, and the software may be updated after a certain time period has elapsed. However, during update of the software, a controller on which the software is provided may be exposed to hacking risk. In other words, when the software is updated, the controller may be infected with advertising programs, malicious codes, and computer viruses, and accordingly, an error such as a temporary stop (e.g., freezing) of the controller due to input/output delay of the controller or lack of storage space may occur.

If a software error occurs in a running vehicle, it is necessary to urgently take action on the vehicle because problems for driving safety may occur.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle configured for taking action on the vehicle when an error occurs in software thereof, and a method of controlling the same.

Additional aspects of the present disclosure are set forth in part in the description which follows, and in part, should be understood from the description, or may be learned by practice of the present disclosure.

In accordance with an aspect of the present disclosure, a method of controlling a vehicle is provided. The method includes inputting, in response to an error occurring in a main controller configured for controlling a motor driving the vehicle, a brake signal of the vehicle to an electronic controller; confirming, in response to the brake signal being input, whether the vehicle decelerates in a drive controller; outputting, upon confirming that the vehicle does not decelerate, by the drive controller, a signal for generating a notification for inducing an emergency button mechanically or electrically connected to the main controller to operate; and cutting off power supplied to the main controller in response to the operation of the emergency button.

The method may further include inputting a communication signal to the electronic controller in response of pressing a start button of the vehicle while the vehicle is driving; and confirming, by the electronic controller, a speed of the vehicle through the drive controller, wherein confirming the speed of the vehicle further includes confirming whether the brake signal has been input upon determining that the speed of the vehicle is greater than or equal to a predetermined value.

In the confirmation of the speed of the vehicle, the predetermined value for the speed of the vehicle may be 5 km/h.

The method may further include, upon confirming that the vehicle does not decelerate, requesting, by the drive controller, a battery controller that is configured to control a main battery that supplies power to the main controller to stop power supply to the main battery.

The method may further include re-confirming, by the drive controller, whether the vehicle is decelerating after the requesting the battery controller to stop the power supply to the main battery, and wherein the inducing of the operation of the emergency button is performed when the deceleration of the vehicle is re-confirmed and the vehicle does not decelerate.

In accordance with another aspect of the present disclosure, a method of controlling a vehicle is provided. The method includes requesting, in response to an error occurring in a main controller configured for controlling a motor driving the vehicle, a battery controller that is configured to control a main battery to stop power supply to the main controller from a drive controller that outputs a drive signal of the motor to the main controller; confirming, by the drive controller, whether the vehicle decelerates; outputting, upon confirming that the vehicle does not decelerate, by the drive controller, a signal for generating a notification for inducing an emergency button mechanically or electrically connected to the main controller to operate; and cutting off power supplied to the main controller in response to the operation of the emergency button.

The method may further include inputting a communication signal to an electronic controller in response of pressing a start button of the vehicle while the vehicle is driving; and confirming, by the electronic controller, a speed of the vehicle through the drive controller, wherein confirming the speed of the vehicle further includes requesting, by the drive controller, the battery controller to stop power supply thereto upon determining that the speed of the vehicle is greater than or equal to a predetermined value.

An inverter may be electrically connected to the main controller so that power is supplied to the main controller, and the emergency button is mechanically or electrically connected to the inverter.

In accordance with another aspect of the present disclosure, a vehicle includes a main battery; a motor configured to drive the vehicle by receiving power from the main battery; a main controller configured to control the motor by use of the power received from the main battery; and an emergency button mechanically or electrically connected to the main controller and configured to cut off the power supplied to the main controller in operation thereof.

The vehicle may further include an inverter connected to the main controller to supply the power from the main battery to the main controller, and wherein the emergency button is mechanically or electrically connected to the inverter.

The vehicle may further include a drive controller configured to monitor a drive of the motor and adjust a torque of the motor through the main controller, and wherein the drive controller is configured to output a signal for generating a notification for inducing the emergency button to operate to a user upon confirming that the vehicle does not decelerate after an error occurs in the main controller.

The vehicle may further include a display configured to generate the notification to the user.

The vehicle may further include a constant power controller configured to control the display so that the notification is generated according to a signal output from the drive controller.

The vehicle may further include a sub battery receiving the power from the main battery and supplying the power to the constant power controller.

The vehicle may further include a low voltage outputter for supplying power from the main battery to the sub battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a control system of a vehicle according to an exemplary embodiment of the present disclosure;

FIG. 2 is a block diagram illustrating an emergency stop device for a vehicle according to an exemplary embodiment of the present disclosure;

FIG. 3 is a flowchart illustrating a method for controlling a vehicle according to an exemplary embodiment of the present disclosure; and

FIG. 4 is a flowchart illustrating a method for controlling a vehicle according to an exemplary embodiment of the present disclosure.

FIG. 5 is a flowchart illustrating a method for controlling a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Reference is made below in detail to the exemplary embodiments of the present disclosure, examples of which are illustrated in the accompanying drawings, wherein like reference numerals refer to like elements throughout. The present specification does not describe all elements of the disclosed exemplary embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Furthermore, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements included in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, various embodiments of the present disclosure are described in detail with reference to the accompanying drawings.

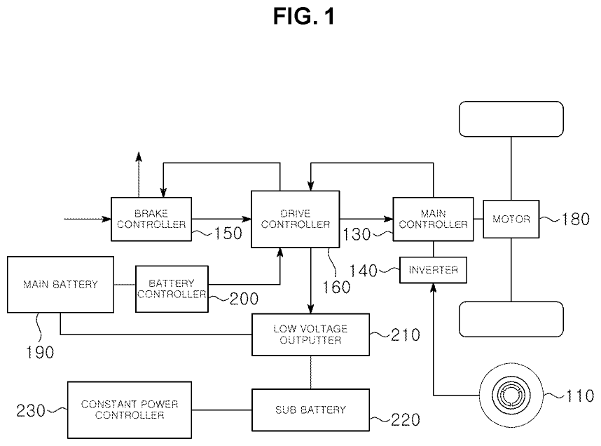

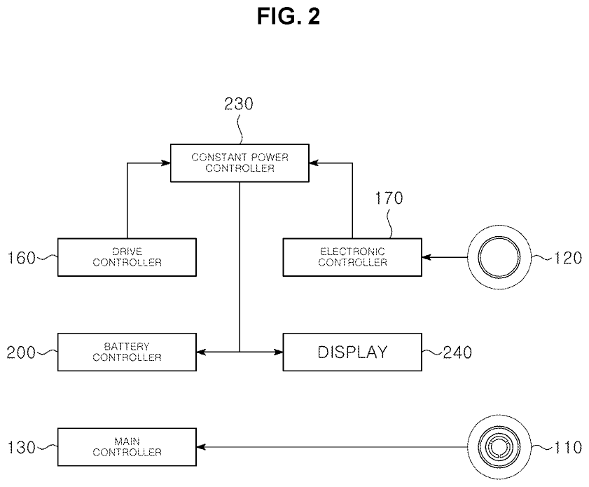

Referring to FIG. 1 and FIG. 2, an emergency stop device for a vehicle according to an exemplary embodiment of the present disclosure is described. The emergency stop device for the vehicle according to an exemplary embodiment of the present disclosure may confirm operations of various devices for driving the vehicle and induce the vehicle to be emergency stopped when an error occurs in a software of the vehicle. To the present end, the emergency stop device of the vehicle may include an emergency button 110, a start button 120, a main controller 130, an inverter 140, a brake controller 150, a drive controller 160, an electronic controller 170, a motor 180, a main battery 190, a low voltage outputter 210, a sub battery 220, a constant power controller 230, and a display 240.

The emergency button 110 may be provided in the vehicle to operate when a user intends to stop the vehicle in an emergency. The emergency button 110 may be provided in a pressing switch type, include a shape such as a wire, a rope or a rod, or adopt a pedal switch type without a cover. Furthermore, the emergency button 110 may be disposed adjacent to a driver seat side so that the user may easily find when an emergency occurs. For example, the emergency button 110 may be provided on a steering wheel or on a left or right of a dashboard based on the steering wheel.

The emergency button 110 is electrically or physically connected to the inverter 140 and may cut off power supplied to the main controller 130 through the inverter 140.

The start button 120 is a button for starting the vehicle so that the vehicle may drive. The start button 120 generates an electrical signal for starting the vehicle. The electrical signal generated through the start button 120 is transmitted to the electronic controller 170, and the motor 180 may be driven through the drive controller 160 so that the vehicle may run.

Furthermore, the start button 120 may be used to stop driving of the vehicle in a state of driving stopped. In other words, the user may turn off an ignition of the vehicle by pressing the start button 120 to stop the vehicle after driving.

The main controller 130 may control the motor 180 for driving the vehicle, and also control the brake controller 150, the drive controller 160, the electronic controller 170, and a battery controller 200. The main controller 130 may transmit an output torque of the motor 180 and an available torque of the motor 180 to the drive controller 160, and receive an instruction for the torque of the motor 180 from the drive controller 160.

The inverter 140 is connected to the main controller 130, and is configured to supply power to the main controller 130. The inverter 140 may be electrically or mechanically connected to the emergency button 110, and block power supply to the main controller 130 due to the operation of the emergency button 110.

The brake controller 150 may control regenerative braking of an electric vehicle used in an exemplary embodiment of the present disclosure to be performed, and control a brake by receiving a signal from a brake pedal position sensor. The brake controller 150 may receive information on an executing amount required for regenerative braking from the drive controller 160, and provide the drive controller 160 with a requested amount of regenerative braking accordingly.

The drive controller 160 may receive information on an actual output torque and available torque of the motor 180 from the main controller 130, and transmit an instruction for the torque of the motor 180 to the main controller 130. The drive controller 160 may collect information on a speed and acceleration of the vehicle through the state of the motor 180 through the main controller 130. Furthermore, the drive controller 160 may control the battery controller 200 to adjust power supplied from the main battery 190 to the main controller 130.

The electronic controller 170 may collect electronic information of the vehicle, confirm whether a brake signal is input from the brake controller 150, and also receive a start ON/OFF signal through the start button 120.

The low voltage outputter 210 steps down the power of the main battery 190 to charge the sub battery 220 with the power of the main battery 190 under the control of the drive controller 160.

The sub battery 220 includes a voltage relatively lower than that of the main battery 190, and is provided to supply power to lamps or wiper of the vehicle.

The constant power controller 230 is electrically connected to the sub battery 220 and receives power from the sub battery 220. The constant power controller 230 may supply power to a controller for controlling safety devices in the vehicle. The constant power controller 230 may operate even when the ignition of the vehicle is turned off, and request the battery controller 200 to turn off a battery relay. Furthermore, the constant power controller 230 may control the display 240 to display the thing that an error has occurred in the software of the vehicle.

The display 240 is disposed to guide various information to the user. In an exemplary embodiment of the present disclosure, the display 240 may be controlled by the constant power controller 230 and may receive power from the sub battery. The display 240 may display the thing that an error has occurred in the software through the constant power controller 230.

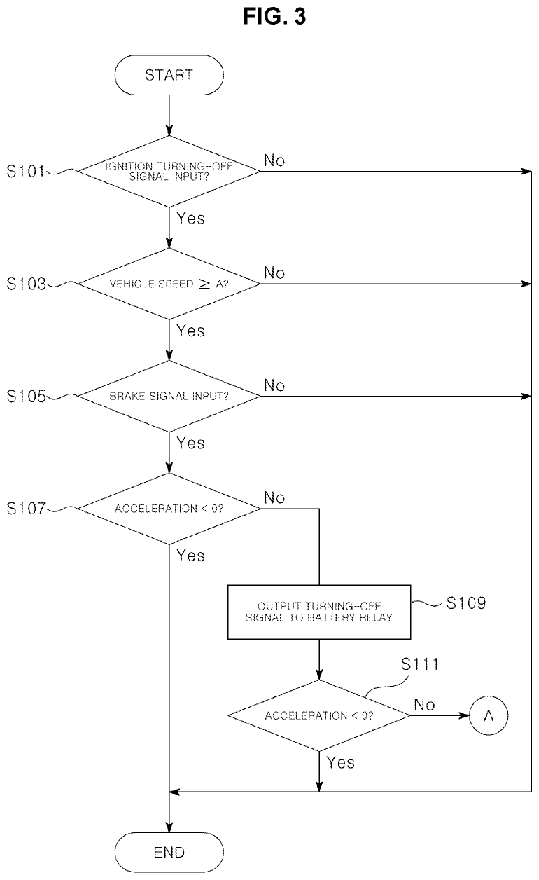

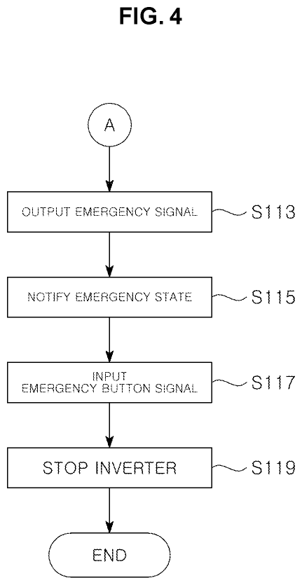

Referring to FIG. 3 and FIG. 4, a method for controlling a vehicle according to an exemplary embodiment of the present disclosure is described below. A method of controlling a vehicle according to an exemplary embodiment of the present disclosure is a method of controlling a running vehicle to stop according to an input signal by a user when an error occurs while driving.

Whether a turning-off signal of the ignition of the vehicle has input after the start button 120 is pressed is confirmed (101).

In a method of controlling the vehicle according to an exemplary embodiment of the present disclosure, when an error occurs in software of the vehicle, a user presses the start button 120, leading to input the turning-off signal of the ignition of the vehicle. In other words, at operation 101, the fact that the start button 120 is pressed by the user while the vehicle is driving may mean that the vehicle is operated against an intention of the user. To prevent the vehicle from being operated against the intention of the user, the electronic controller 170 confirms whether the turning-off signal of the ignition thereof has input due to the pressing of the start button 120.

At operation 101, if the turning-off signal of the ignition thereof is not input, the instant process ends.

However, operation 101 may be omitted if necessary. Even if the start button 120 is not pressed by the user, the next operation may be performed when an error occurs in the software.

Whether a speed of the vehicle is greater than or equal to a predetermined value A is determined (103).

The electronic controller 170 confirms whether the speed of the vehicle is greater than or equal to the predetermined valueA (e.g., 5 km/h) through the drive controller 160. The electronic controller 170 may confirm whether the speed of the vehicle is greater than or equal to the predetermined value, and upon determining that the speed of the vehicle is greater than or equal to the predetermined value, may determine that the vehicle will not be easily stopped by the intension of the user.

The instant process ends upon determining that the speed of the vehicle is less than the predetermined value.

Whether a brake signal has input is confirmed (105).

The electronic controller 170 confirms whether the brake signal has input through the brake controller 150 upon determining that the speed of the vehicle exceeds the predetermined value. The brake controller 150 may confirm whether the signal for operating the brake has input after the brake pedal is pressed by the intention of the user, and the electronic controller 170 may confirm whether the brake signal is received from the brake controller 150.

If the brake signal is not input to the electronic controller 170 through the brake controller 150, the instant process ends. The fact that the user does not operate the brake by the pressing of the brake pedal may be determined that the vehicle is controlled to move a predetermined distance although an error occurs in the software.

Whether an acceleration of the vehicle is less than 0 is confirmed (107).

The electronic controller 170 confirms whether the acceleration of the vehicle is less than 0 through the drive controller 160. In other words, the electronic controller 170 may confirm whether the vehicle decelerates by use of the drive controller 160, which may refer to confirm whether the vehicle decelerates according to the brake signal input through operation 105.

Upon determining that the acceleration of the vehicle is less than 0, all processes ends. The fact that the vehicle decelerates refers to that the brake is operated normally by the brake signal input in operation 105. As a result, the vehicle may be stopped by the normal operation of the brake, so that all process may end.

A turning-off signal is output to the battery relay (109).

At operation 107, upon determining that the acceleration of the vehicle is not less than 0, it means that the vehicle is not decelerating although the brake signal is input in operation 105. Accordingly, the drive controller 160 may output the turning-off signal for cutting off power of the main battery 190 to the battery controller 200.

Whether the acceleration of the vehicle is less than 0 is confirmed (111).

The drive controller 160 confirms whether the acceleration of the vehicle is less than 0. At operation 109, the drive controller 160 may be configured to determine that the power supplied from the main battery 190 to the motor 180 has cut off based on the outputting of the turning-off signal to the battery controller 200, and confirm whether the vehicle is decelerating. When the drive controller 160 confirms that the vehicle is decelerating, the instant process ends.

A signal for an emergency state is output (113).

As a result of confirming through operation 111, upon determining that the vehicle does not decelerate, the drive controller 160 outputs the signal for the emergency state (or an emergency signal). At the instant time, the drive controller 160 outputs the emergency signal to the display 240.

The emergency state is notified to the user (115).

Upon receiving the emergency signal from the drive controller 160, the display 240 displays and informs the user that an emergency has occurred. Accordingly, the user may be induced to press the emergency button 110.

A signal of the emergency button 110 is input (117).

After the emergency button 110 is pressed by the user, the signal of the emergency button 110 is input. In other words, to urgently stop the vehicle, the user presses the emergency button 110 disposed adjacent to a driver seat side, so that the signal of the emergency button 110 is input to the drive controller 160.

An operation of the inverter 140 is stopped (119).

In response to the emergency button 110 being pressed through operation 117, the operation of the inverter 140 mechanically or electrically connected to the emergency button 110 is stopped, and thus the power supplied to the main controller 130 may be cut off. Accordingly, the inverter 140 is forcibly stopped and the power supplied to the motor 180 is cut off, so that the motor 180 prevents wheels of the vehicle from rotating, resulting in generating a brake effect. In other words, because the power supplied to the motor 180 is forcibly cut off, the motor 180 hinders the rotation of the wheels even when the wheels rotates, so that the brake effect may be generated by acting as a speed reducer provided by the rotation of the wheels.

Accordingly, even if all processes such as turning off the ignition thereof through the start button 120, disabling the brake operation, and cutting off the power supply of the main battery 190, while driving due to a software error, do not operate, the driving of the vehicle may be stopped.

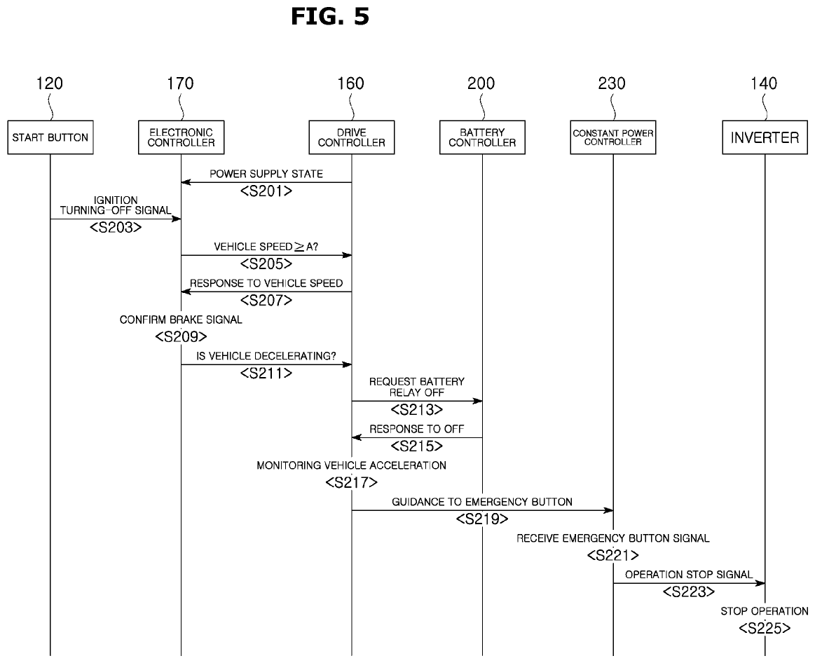

Referring to FIG. 5, a method for controlling a vehicle according to an exemplary embodiment of the present disclosure is described in more detail.

The power supply state has been maintained (201).

When the vehicle is on running, power supplied to the electronic controller 170 through the drive controller 160 is maintained. In other words, power supplied from the main battery 190 is normally supplied to the main controller 130, the drive controller 160, and the electronic controller 170.

The turning-off signal is input (203).

Upon confirming that an abnormal state of the vehicle has occurred while driving, the user presses the start button 120 to turn off the ignition thereof even while driving, resulting in inputting the turning-off signal to the electronic controller 170.

Whether the speed of the vehicle is greater than or equal to the predetermined value A is requested (205).

The electronic controller 170 requests the drive controller 160 whether the speed of the vehicle is greater than or equal to the predetermined value A (e.g., 5 km/h). The electronic controller 170 requests information regarding the speed of the vehicle to the drive controller 160 to confirm the speed of the vehicle.

A response to the speed of the vehicle is returned (207).

The response to operation 205 is transmitted from the drive controller 160 to the electronic controller 170. The response may be yes or no as a response to whether the speed of the vehicle is greater than or equal to the predetermined value A.

Whether the brake signal has been input is confirmed (209).

In response to the speed of the vehicle exceeding the predetermined value, the electronic controller 170 confirms whether the brake signal has been input through the brake controller 150. The electronic controller 170 may confirm whether the brake signal, which is a signal for operating the brake has been input by the pressing of the brake pedal due to the intention of the user, is input from the brake controller 150.

Whether the acceleration of the vehicle is less than 0 is confirmed (211).

The electronic controller 170 confirms whether the acceleration of the vehicle is less than 0 through the drive controller 160. In other words, the electronic controller 170 may transmit a request to the drive controller 160 to check whether the vehicle is decelerating.

The turning-off signal is requested to the battery relay (213).

Upon request from the electronic controller 170 in operation 211, the drive controller 160 is configured to determine, upon confirming that the acceleration thereof is not less than 0, that the vehicle is not decelerating even by the brake signal input in operation 209. As a result, the drive controller 160 may output the turning-off signal for cutting off power of the main battery 190 to the battery controller 200.

The response to the battery relay off signal request is input (215).

The drive controller 160 receives the response from the battery controller 200 regarding the fact that the power supplied from the main battery 190 to the motor 180 is stopped. Herein, the drive controller 160 may receive the response from the battery controller 200 indicating that the power is cut off or may receive the response that the power is not cut off.

The acceleration of the vehicle is monitored (217).

The drive controller 160 monitors whether the vehicle is accelerating. The drive controller 160 monitors whether the vehicle is accelerating without decelerating despite the response in operation 215.

Herein, the instant process may end upon determining that the vehicle is decelerating.

The user is guided to press the emergency button 110 (219).

As a result of monitoring in operation 217, upon confirming that the vehicle is not decelerating, the drive controller 160 outputs a signal to the constant power controller 230 so that a guide signal is displayed to induce the user to press the emergency button 110. At the instant time, the constant power controller 230 may control the display 240 to display a guide for inducing the user to press the emergency button 110.

The signal of the emergency button 110 is input (221).

In response to the emergency button 110 being pressed by the user, the signal of the emergency button 110 is input. To urgently stop the vehicle, the user presses the emergency button 110 disposed adjacent to the driver seat side so that the signal of the emergency button 110 is input to the drive controller 160.

An operation stop signal is output (223).

In response to the signal of the emergency button 110 being input, the constant power controller 230 outputs the operation stop signal to the inverter 140 so that the operation of the inverter 140 is stopped.

The operation of the inverter 140 is stopped (225).

In response to the operation stop signal being input, the inverter 140 stops operating, and accordingly, the power supplied to the main controller 130 may be cut off. As a result, the inverter 140 is forcibly stopped and the power supplied to the motor 180 is cut off, so that rotation of the wheels is hindered by the motor 180, resulting in a braking effect.

As is apparent from the above, various embodiments of the present disclosure may provide, when an error occurs in the software of the vehicle while the user is driving the vehicle, a vehicle configured for urgently stopping by use of the emergency button, preventing an accident while driving.

Furthermore, according to various embodiments of the present disclosure, the inverter is forcibly stopped through the emergency button, resulting in operating as a speed reducer due to resistance of the motor. Therefore, a brake effect occurs and accordingly the vehicle may stably be stopped.

On the other hand, the above-described embodiments may be implemented in the form of a recording medium storing instructions executable by a computer. The instructions may be stored in the form of program code. When the instructions are executed by a processor, a program module is generated by the instructions so that the operations of the disclosed exemplary embodiments of the present disclosure may be conducted. The recording medium may be implemented as a computer-readable recording medium.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling a vehicle, the method comprising:
inputting, in response to an error occurring in a main controller configured for controlling a motor driving the vehicle, a brake signal of the vehicle to an electronic controller;
confirming, in response to the brake signal being input, whether the vehicle decelerates in a drive controller;
outputting, upon confirming that the vehicle does not decelerate, by the drive controller, a signal for generating a notification for inducing an emergency button mechanically or electrically connected to the main controller to operate; and
cutting off, by the drive controller, power supplied to the main controller in response to the operation of the emergency button.

2. The method of claim 1, further including:
inputting a communication signal to the electronic controller in response of pressing a start button of the vehicle while the vehicle is driving; and
confirming, by the electronic controller, a speed of the vehicle through the drive controller;
wherein the inputting the brake signal of the vehicle is performed when the speed of the vehicle is greater than or equal to a predetermined value.

3. The method of claim 2, wherein in the confirmation of the speed of the vehicle, the predetermined value for the speed of the vehicle is 5 km/h.

4. The method of claim 1, further including:
upon confirming that the vehicle does not decelerate, requesting, by the drive controller, a battery controller configured to control a main battery that supplies the power to the main controller, to stop power supply to the main battery.

5. The method of claim 4, further including re-confirming, by the drive controller, whether the vehicle is decelerating after the requesting the battery controller to stop the power supply to the main battery, and
wherein the inducing of the operation of the emergency button is performed when the deceleration of the vehicle is re-confirmed and the vehicle does not decelerate.

6. A method of controlling a vehicle, the method including:
requesting, in response to an error occurring in a main controller configured for controlling a motor driving the vehicle, a battery controller configured to control a main battery, to stop power supply to the main controller from a drive controller that outputs a drive signal of the motor to the main controller;
confirming, by the drive controller, whether the vehicle decelerates;
outputting, upon confirming that the vehicle does not decelerate, by the drive controller, a signal for generating a notification for inducing an emergency button mechanically or electrically connected to the main controller to operate; and
cutting off, by the battery controller, power supplied to the main controller in response to the operation of the emergency button.

7. The method of claim 6, further including:
inputting a communication signal to an electronic controller in response of pressing a start button of the vehicle while the vehicle is driving; and
confirming, by the electronic controller, a speed of the vehicle through the drive controller;
wherein requesting the battery controller to stop the power supply is performed when the speed of the vehicle is greater than or equal to a predetermined value.

8. The method of claim 6,
wherein an inverter is electrically connected to the main controller so that the power is supplied to the main controller therethrough, and
wherein the emergency button is mechanically or electrically connected to the inverter.

9. A vehicle, comprising:
a main battery;
a motor configured to drive the vehicle by receiving power from the main battery;
a main controller configured to control the motor by use of the power received from the main battery; and
an emergency button mechanically or electrically connected to the main controller and configured to cut off the power supplied to the main controller in operation thereof.

10. The vehicle of claim 9, further including an inverter connected to the main controller to supply the power from the main battery to the main controller therethrough, and
wherein the emergency button is mechanically or electrically connected to the inverter.

11. The vehicle of claim 9, further including a drive controller configured to monitor a drive of the motor and adjust a torque of the motor through the main controller,
wherein the drive controller is further configured to output a signal for generating a notification for inducing the emergency button to operate to a user upon confirming that the vehicle does not decelerate after an error occurs in the main controller.

12. The vehicle of claim 11, further including a display configured to generate the notification to the user.

13. The vehicle of claim 12, further including a constant power controller configured to control the display so that the notification is generated according to a signal output from the drive controller.

14. The vehicle of claim 13, further including a sub battery receiving the power from the main battery and supplying the power to the constant power controller.

15. The vehicle of claim 14, further including a voltage outputter for supplying the power from the main battery to the sub battery.

16. The vehicle of claim 11, further including an electronic controller and a start button connected to the electronic controller, wherein in response to the error occurring in the main controller, a brake signal of the vehicle is input to the electronic controller configured for collecting electronic information of the vehicle, confirming whether the brake signal is input from the brake controller and receiving a start ON/OFF signal through the start button.

17. The vehicle of claim 11, further including a battery controller configured to control the main battery, to stop power supply to the main controller from the drive controller that outputs a drive signal of the motor to the main controller, wherein the battery controller is configured for cutting off the power supplied to the main controller in response to the operation of the emergency button.

18. The vehicle of claim 17, wherein requesting the battery controller to stop the power supply to the main controller is performed when a speed of the vehicle is greater than or equal to a predetermined value.

19. The vehicle of claim 18, wherein upon confirming that the vehicle does not decelerate, the drive controller is configured for requesting the battery controller to stop the power supply to the main battery.

20. The vehicle of claim 19,
wherein the drive controller is further configured for re-confirming whether the vehicle is decelerating after the requesting the battery controller to stop the power supply to the main battery, and
wherein the inducing of the operation of the emergency button is performed when the deceleration of the vehicle is re-confirmed and the vehicle does not decelerate.
